(19) United States
(12) Patent Application Publication
(10) Pub. No.: US 2008/0016544 A1
(43) Pub. Date: Jan. 17, 2008

(54) DISPLAY SYSTEM AND CONTROL METHOD THEREOF

(75) Inventors: Yi-Hsiu Lee, Taipei (TW); Jui-Shun Pan, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/778,099

(22) Filed: Jul. 16, 2007

(30) Foreign Application Priority Data
Jul. 14, 2006 (TW) 95125794

(51) Int. Cl. H04N 7/173; H04N 7/16

(52) U.S. Cl. 725/134; 725/142; 725/89

(57) ABSTRACT

A display system for automatically pausing/resuming a function and a control method thereof are provided, wherein the display system includes a photography module, a display module and a control module. The photography module is used to retrieve at least one characteristic of the user. The display module is used to display a video. The control module electrically connected to the display module and the photography module includes a characteristic identification unit and a control unit. The characteristic identification unit is used to identify the characteristics of the user. According to the result of identification, the control unit is used to control the display system to pause/resume a function.

### CROSS-REFERENCE TO RELATED APPLICATION

This application claims the priority benefit of Taiwan application serial no. 95125794, filed Jul. 14, 2006. All disclosure of the Taiwan application is incorporated herein by reference.

### BACKGROUND OF THE INVENTION

1. Field of the Invention

The present invention relates to a display system. More particularly, the present invention relates to a display system for automatically pausing/resuming a function and a control method thereof.

2. Description of Related Art

When operating an electronic device, the user usually has to pause for some reasons. For example, the user usually cannot finish a film uninterruptedly on a family audio-visual system due to some events (such as answering the phone, going to the bathroom, fetching water). Before handling the event, the user has to manually (usually by a control key or a remote control) operate the audio-visual playback apparatus (for example, a DVD video tape machine) to pause playing the film; and after handling the event, the user still has to manually operate the playback software to resume playing the film. However, if the event is so urgent that the user has no time to operate the playback software to pause, the user still has to manually play back the film to the previous position to resume watching the film after handling the sudden event. Obviously, the above situation may result in many inconveniences in use. Although a timing apparatus is used in the conventional art to pause the operation of an electronic device, the events still cannot be dealt with, and the application of the timing apparatus is easy to cause unwanted inconvenience to the user. For example, in the above situation of watching TV, as the timing apparatus is initiated to turn off the TV at a set time, the user may have to pause at an exciting segment as the TV is turned off, which may further affect the watching enthusiasm of the user.

As the design and manufacture of the current electronic devices have not achieved the function of automatically pausing/resuming an operation according to the status of the user, whenever a situation or an event comes up, it is likely to cause many inconveniences to the user such as pausing or resuming the operation.

### SUMMARY OF THE INVENTION

In view of the above, an objective of the present invention is to provide a display system capable of executing automatic pausing/resuming function via identifying the characteristics of the user.

Another objective of the present invention is to provide a method of controlling the display system for automatically controlling the display system to pause/resume a function via identifying the characteristics of the user.

In view of the above or other objectives, the present invention provides a display system, which comprises a photography module, a display module and a control module. The photography module is used to retrieve the characteristics of the user, the display module is used to display the video content, and the control module connected to the photography module and the display module comprises a characteristic identification unit and a control unit. The characteristic identification unit is used to identify the characteristics of the user, and the control unit is used to control the display system according to the result of identification.

The present invention further provides a method of controlling the display system. The display system comprises a photography module and a display module for displaying a video. The method of controlling the display system comprises: retrieving at least one characteristic of the user using the photography module; identifying the characteristics of the user; and controlling the display module according to the identified characteristics of the user.

The display system described according to a preferred embodiment of the present invention further comprises an audio-visual playback module for playing video. The display module is used to display the video played using the audio-visual playback module, and the control unit is used to control the audio-visual playback module to pause or resume playing of the video according to the characteristics of the user.

In the display system described according to the preferred embodiment of the present invention, the control unit further controls the display module to pause or resume displaying the video according to the characteristics of the user.

In the display system described according to the preferred embodiment of the present invention, when eyes of the user characteristic are taken off the display module, the display system pauses displaying under the control of the control module; while when eyes of the user characteristic are moved back the display module, the display system resumes displaying under the control of the control module.

In the display system described according to the preferred embodiment of the present invention, when the action of the user conforms to a first preset action, the display system pauses displaying under the control of the control module; when the action of the user conforms to a second preset action, the display system resumes displaying under the control of the control module.

In the display system described according to the preferred embodiment of the present invention, when the user is not involved in the retrieved image, the display system pauses displaying under the control of the control module; while when the user is involved in the retrieved image, the display system resumes displaying under the control of the control module.

In the display system described according to the preferred embodiment of the present invention, the control module compares the number of the user with the preset number, and the display system determines whether to pause or resume displaying according to the above comparison result.

In the display system described according to the preferred embodiment of the present invention, the characteristic identification unit is used to identify the distance between the user and the display frame, the control module further compares the above distance between the user and the display frame with the preset distance, and the display system determines whether to pause or resume displaying according to the above comparison result.

The display system of the present invention adopts combining the photography module and the control module, retrieves the characteristics of the user via the photography module, and then identifies the characteristics of the user via the control module to automatically pause/resume a function of the system.

In order to make the aforementioned and other objectives, features and advantages of the present invention comprehensible, preferred embodiments accompanied with figures are described in detail below.

### BRIEF DESCRIPTION OF THE DRAWINGS

FIG. 1 is a schematic block diagram of a display system according to a preferred embodiment of the present invention.

FIG. 2 is a block diagram of the display system used in a public telephone according to a preferred embodiment of the present invention.

FIG. 3 is a block diagram of the display system used in a monitoring system according to a preferred embodiment of the present invention.

FIG. 4 is an image of the user retrieved by the photography module according to a preferred embodiment of the present invention.

FIG. 5 is an image of the user retrieved by the photography module according to a preferred embodiment of the present invention.

FIG. 6 is an image of the user retrieved by the photography module according to a preferred embodiment of the present invention.

FIG. 7 is an image of the user retrieved by the photography module according to a preferred embodiment of the present invention.

FIG. 8 is an image of the user retrieved by the photography module according to a preferred embodiment of the present invention.

FIG. 9 is an image of the user retrieved by the photography module according to a preferred embodiment of the present invention.

FIG. 10 is a block diagram of an audio-visual playback system according to a preferred embodiment of the present invention.

FIG. 11 is a block diagram of an example of the audio-visual playback system according to a preferred embodiment of the present invention.

FIG. 12 is a block diagram of an example of the audio-visual playback system according to a preferred embodiment of the present invention.

FIG. 13 is a block diagram of an example of the audio-visual playback system according to a preferred embodiment of the present invention.

FIG. 14 is a block diagram of an example of the audio-visual playback system according to a preferred embodiment of the present invention.

### DESCRIPTION OF EMBODIMENTS

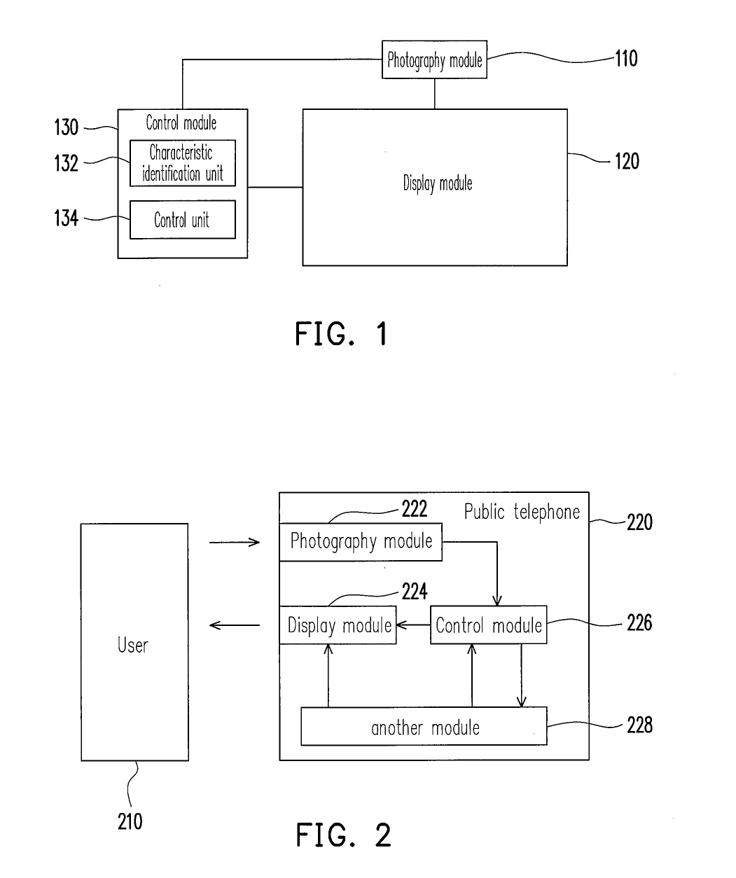

FIG. 1 is a schematic block diagram of a display system according to a preferred embodiment of the present invention. As shown in FIG. 1, the display system comprises a photography module 110, a display module 120 and a control module 130. The display module 120 (such as the display of a TV set or the display of a communication apparatus) is used to display the video content. The photography module 110 is adapted for retrieving and transferring at least one characteristic of the user to the control module 130. The photography module 110 can be, but not limited to, a camera or any other equipments having image retrieving function. After receiving the characteristics of the user, the control module 130 controls the apparatus automatically by judging different characteristics of the user.

The above characteristics of the user can be the characteristics of the face image of the user, eyes of the user, actions of the user or others. The characteristic identification unit 132 in the control module 130 further judges the characteristics of the user, and the control unit 134 in the control module 130 controls the display system of the present embodiment according to the characteristics of the user identified by the characteristic identification unit 132. Those of ordinary skill in the art can achieve the above actions of retrieving and judging the characteristics of the user by using any other technology. For example, Mr. Jon Wetzel in the context aware computing group of MIT Media Lab. disclosed a face detecting technology in 2005. Mr. Jon Wetzel has published the source code of the face detecting technology for the public to use.

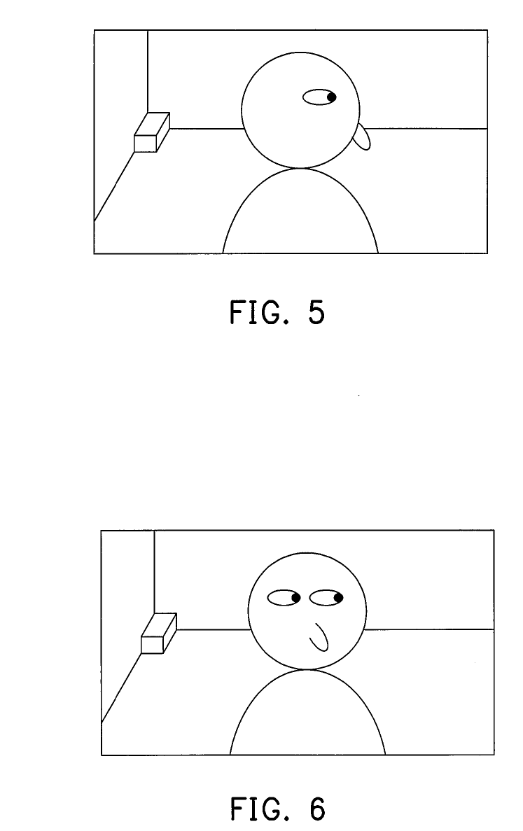

For example, when the attention of the user is distracted to other places, the display system of the present embodiment automatically pauses displaying the video, so as to achieve the purpose of saving electric power and preventing the user from missing the video content. FIGS. 4 and 5 are the images of the user retrieved by the photography module 110 in FIG. 1. As shown in FIG. 5, when the user faces other places, the characteristic identification unit 132 identifies that eyes of the user characteristic are taken off the display module 120 (i.e. the line of sight of the two eyes of the user is not concentrated on the display module 120) by capturing the number of the eyes of the user in the image (or by other ways). Accordingly, the control unit 134 pauses the video display actions on the display module 120, till the frame of the user retrieved by the photography module 110 again faces the display module 120 (as shown in FIG. 4). When the characteristic identification unit 132 judges by the eyes of the user characteristic are moved back the display module 120 (i.e. the line of sight of the user that the attention of the user has returned to the display module 120), the control unit 134 controls the display system of the present embodiment to resume displaying the video frames.

The characteristic identification unit 132 can control the display system of the present embodiment by analyzing the characteristics of the eye image of the user. FIG. 6 is an image of the user retrieved by the photography module 110 in FIG. 1. As shown in FIG. 6, when the user faces the display module 120 but the line of sight of the eyes faces other places, the control unit 134 judges that the user does not concentrate the attention on the display module 120 and thus pauses displaying the video frames. When the line of sight of the eyes of the user returns to the display module 120 (as shown in FIG. 4), the display system of the present embodiment resumes displaying the video frames under the control of the control unit 134.

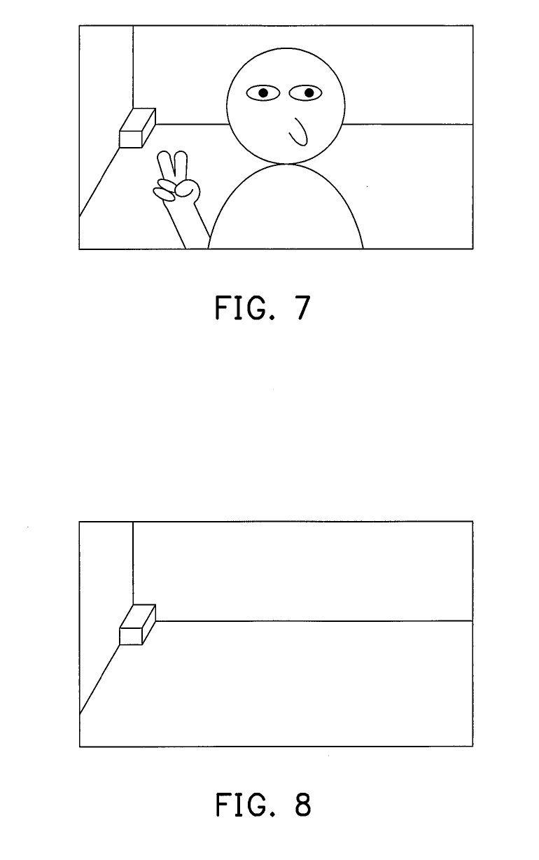

The characteristic identification unit 132 can control the display system of the present embodiment by judging whether the action of the user conforms to a certain preset action. FIG. 7 is an image of the user retrieved by the photography module 110 in FIG. 1. As shown in FIG. 7, when the control module 130 receives an image of the user, the characteristic identification unit 132 identifies the meaning of the instruction of the V-shaped gesture of the user, and accordingly the control unit 134 controls the display system (for example, to pause displaying frames). When the photography module 110 retrieves another image of the user (as shown in FIG. 4), and the characteristic identification unit 132 identifies the meaning of the instruction of the hand waving gesture of the user, the display system of the present embodiment is automatically controlled again to perform the corresponding instructed action (for example, to resume displaying frames).

The display system of the present embodiment can also determine whether to resume or pause displaying frames according to whether or not the user leaves the seat. When no image of the user is involved in the image retrieved by the photography module 110 (as shown in FIG. 8), the system pauses displaying video frames under the control of the control module 130. Until the photography module 110 retrieves the image of the user, the system resumes displaying the video frames. Moreover, the display system of the present embodiment can determine whether to resume or pause displaying frames according to the number of the users. For example, when the display system is utilized to display private frames, the content of the frames is not intended to be peeped by others, so it is necessary to limit the number of the users. If the user is involved in the images retrieved by the photography module 110, the system further judges whether the number of the users exceeds the preset number, wherein the preset number is set by the user in advance. After comparing the number of the users with the preset number, if the number of the user does not exceed the preset value, the control module 130 controls the display module 120 to display the private frames; while if the number of the user exceeds the preset value, the control module 130 controls the display module 120 to pause displaying the private frames, so as to preserve the secret.

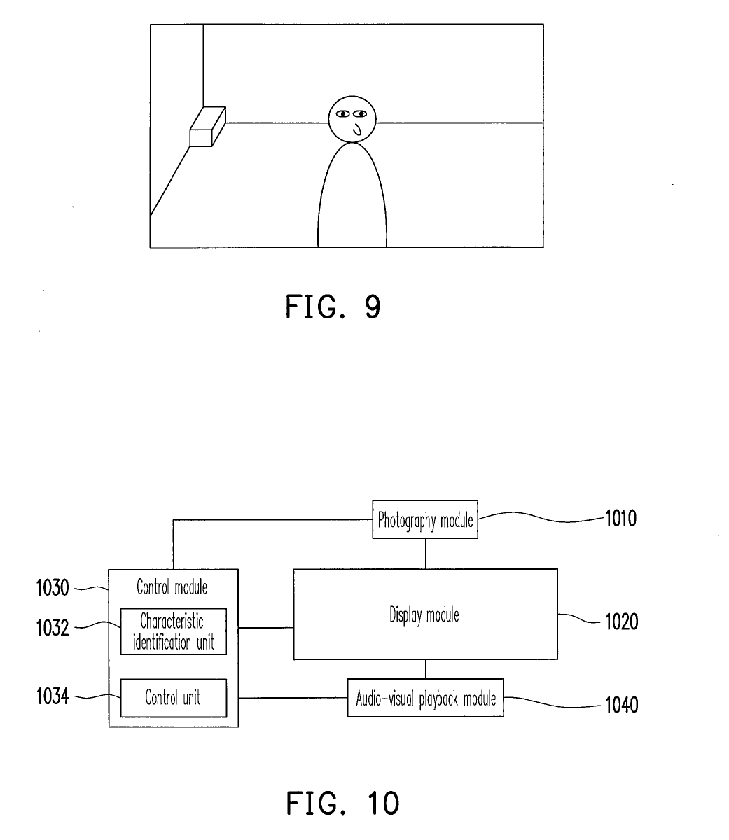

Furthermore, the characteristic identification unit 132 can control the display system by identifying the distance between the user and the display module 120. FIG. 9 is an image of the user retrieved by the photography module 110 in FIG. 1. Under common circumstances, when the distance between the user and the display exceeds a certain range, which usually means that the user is performing other actions, the display function of the present system is turned off to save electric power. For example, in FIG. 9, when the characteristic identification unit 132 judges that the user has exceeded the preset distance by, for example, the size proportion of people, the display of the frames is paused until the user returns to an appropriate distance. Further, when the display system is applied to a TV set with the sight protection function, if the distance between the user and the TV set is smaller than the preset value (for example, 50 cm), which means the user is too close to the TV set, the screen of the TV set is turned off to achieve the purpose of sight protection. The preset distance can be set by the user in advance to meet different requirements.

FIG. 2 is a block diagram of the display system applied to a public telephone according to the preferred embodiment of the present invention. As most of the public telephones currently mounted in the places such as rapid-transit stations have the function of querying shifts and playing commercial advertisements, it requires considerable amount of electric power to display these frames all day long and also accelerates the wearout of the display panels of the public telephones. Referring to FIG. 2, a public telephone 220 comprises a photography module 222, a display module 224, a control module 226 and another module 228. The photography module 222 built in the public telephone 220 transmits the retrieved image to the control module 226. The control module 226 controls the display module 224 (for example, the display panel) of the public telephone according to the received image. When a user 210 approaches the public telephone 220, the photography module 222 of the public telephone 220 retrieves the image of the user 210. After the image is transmitted to the control module 226, the control module 226 accordingly judges that someone will use the public telephone 220, and then displays the frame of query function or content of advertisements on the display module 224. However, if no one uses the public telephone 220 (for example, the photography module 222 captures no frame indicating no user is approaching), the display module 224 of the public telephone 220 does not perform any display actions, so as to save the electric power. It should be noted that, when the control module 226 controls the display module 224 according to the image transmitted from the photography module 222, another module 228 in the public telephone 220 for providing the function such as dialing operates properly without being affected. Besides the display panel of the public telephone, the display system of the present invention can also be applied to any communication apparatuses with display modules such as 3rd Generation (3G) cellular phones or wireless transceivers, so as to achieve the purpose of saving electric power and prolonging the service life of the display module.

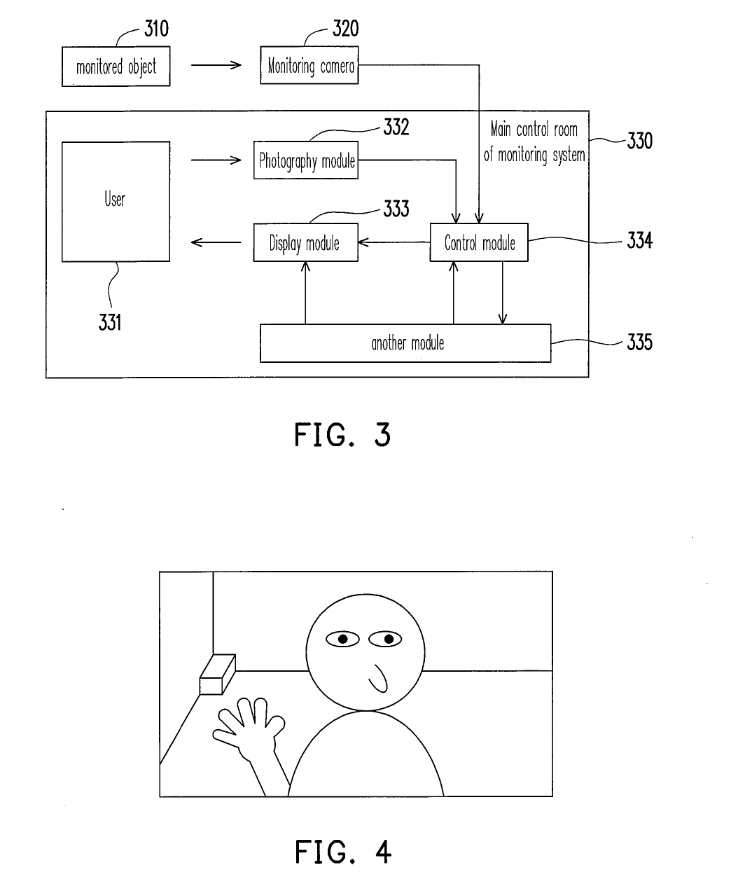

The present invention can also be applied to the security monitoring system in campuses or communities. A conventional security monitoring system transmits the image shot by the monitoring camera to the main control room of the monitoring system, and then records and displays the image. As the main control room of the monitoring system usually has lots of display modules (for example, TV screens) for displaying the images transmitted from each monitoring camera, when the guard or security personnel leaves the main control room for the time being, it may save considerable electric power without affecting the monitoring effect by pausing display while keeping recording. FIG. 3 is a block diagram of the display system used in a monitoring system according to the preferred embodiment of the present invention. In the present embodiment, the image of a monitored object 310 is shot by a monitoring camera 320, and then transmitted to the main control room of a monitoring system 330. The main control room of the monitoring system 330 comprises a photography module 332, a display module 333, a control module 334 and another module 335. When a user 331 enters the main control room of the monitoring system 330, the photography module 332 retrieves and transmits the characteristic or state of the user 331 to the control module 334. Then, the control module 334 determines whether to display the image of the monitored object 310 transmitted from the monitoring camera 320 on the display module 333. When the control module 334 determines not to display the image (for example, the photography module 332 cannot retrieve any image of the user 331), the display module 333 turns off the display function to save electric power, but another module 335 in the main control room of the monitoring system 330 keeps operating without being affected, for example, the storage medium still records the image shot and transmitted from the monitoring camera 320. However, when the photography module 332 retrieves the image of the user 331, the characteristics of the user (such as the line of sight, face expressions, actions of the user) are further analyzed. For example, when the control module 334 analyzes that the line of sight of the user is not on the display module 333, the control module 334 initiates another module 335 (for example, playing the warning sound), so as to inform the user 311 to monitor intently. Likewise, those of ordinary skill in the art can shoot and analyze the characteristics of the user, so as to design a monitoring system which can automatically determine corresponding functions according to the current status of the user.

FIG. 10 is a block diagram of an audio-visual playback system according to the preferred embodiment of the present invention. The present system comprises a photography module 1010, a display module 1020, a control module 1030 and an audio-visual playback module 1040. The photography module 1010 is used to retrieve at least one characteristic of the user. The audio-visual playback module 1040 is used to play the video content. The display module 1020 is used to display the video content played by the audio-visual playback module 1040. A characteristic identification unit 1032 in the control module 1030 is used to identify the characteristics of the user. It should be noted that, according to the result of identification, a control unit 1034 can not only control whether or not the display module 1020 should resume displaying the frames, but also control the audio-visual playback module 1040 to pause or resume playing the video content. The audio-visual playback module 1040 can be a DVD audio-visual player or other apparatuses for playing the audio-visual content, and the display module 1020 can be, but not limited to, an apparatus having display function such as the display of a TV set or a computer screen. In the present embodiment, the characteristics of the user can be the characteristics of face image of the user, eyes of the user, actions of the user or others. The characteristics of the user identified by the characteristic identification unit 1032 are the same as above, and will not be described in detail herein.

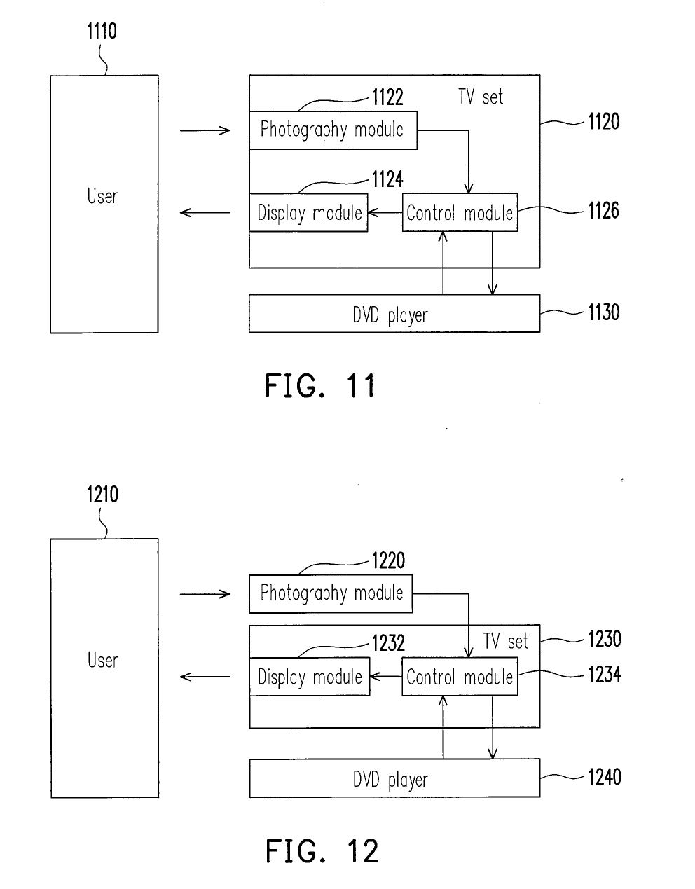

FIG. 11 is a block diagram of an example of the audio-visual playback system according to the preferred embodiment of the present invention. In the present embodiment, a TV set 1120 comprises a photography module 1122, a display module 1124 and a control module 1126. The TV set 1120 is connected to a DVD audio-visual player 1130 having the function of playing multimedia films. A user 1110 utilizes the DVD audio-visual player 1130 to play a film, and the TV set 1120 displays the content of the film for watching. The photography module 1122 built in the TV set 1120 retrieves and transfers the image of the user 1110 to the control module 1126. Then, the control module 1126 determines whether to resume playing the DVD film according to the characteristics of the user 1110. For example, if the control module 1126 judges that the user 1110 is not in front of the TV set 1120 or identifies that the attention of the user 1110 is not concentrated on the played film, the control module 1126 not only issues an instruction to the display module 1124 to pause displaying the content of the film, but also orders the DVD audio-visual player 1130 to pause the playing actions of the film. Until the control module 1126 determines to resume playing the film according to the characteristics of the user retrieved by the photography module 1122, the DVD audio-visual player 1130 is informed to resume playing the film and displays the played content on the display module 1124.

FIG. 12 is a block diagram of an example of the audio-visual playback system according to the preferred embodiment of the present invention. The present embodiment comprises a photography module 1220, a DVD audio-visual player 1240 and a TV set 1230 connected to the above two apparatuses. The present embodiment is similar to the system in FIG. 11 except for the photography module 1220 is being externally connected to the TV set 1230, so any photography devices having retrieving function can be utilized in the present embodiment. The photography module 1220 retrieves and transfers the characteristics of a user 1210 to the control module 1234 in the TV set 1230, and then the control module 1234 controls the DVD audio-visual player 1240 and the display module 1232 in the TV set 1230, so as to automatically control whether to resume playing and displaying or pause playing and displaying the content of a film.

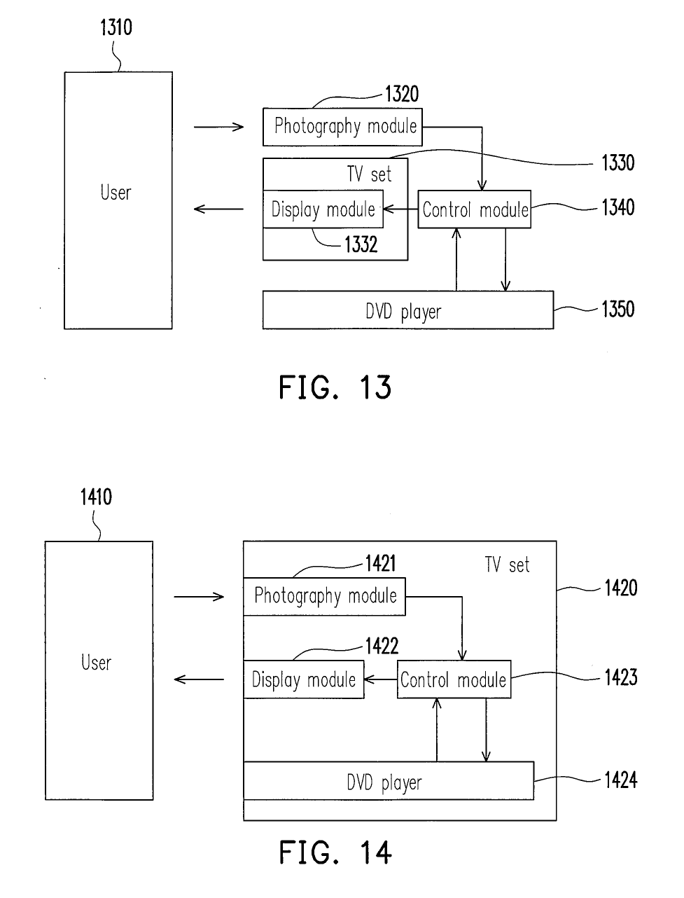

FIG. 13 is a block diagram of an example of the audio-visual playback system according to the preferred embodiment of the present invention. In the present invention, a conventional TV set is externally connected to other modules to achieve the effect of automatically playing films. The present embodiment comprises a TV set 1330 with a built-in display module 1332, a photography module 1320, a control module 1340 and a DVD audio-visual player 1350. The photography module 1320 retrieves and transfers the characteristics of a user 1310 to the control module 1340, and then the control module 1340 controls the TV set 1330 and the DVD audio-visual player 1350 according to the characteristics. The control module 1340 can be any apparatus having control function such as a set top box, which controls the TV set 1330 and the DVD audio-visual player 1350 by means of, for example, infrared transmission.

FIG. 14 is a block diagram of an example of the audio-visual playback system according to the preferred embodiment of the present invention. Alternatively, a TV set 1420 comprises a photography module 1421, a display module 1422, a control module 1423 and a DVD audio-visual player 1424. Likewise, the photography module 1421 retrieves and transfers the characteristics of a user 1410 to the control module 1423, and then the control module 1423 controls the display module 1244 and the DVD audio-visual player 1424 according to the characteristics. As the TV set 1420 itself has the function of playing and displaying the audio-visual frames, and also can automatically control whether to pause or resume playing and displaying the audio-visual frames, the TV set 1420 does not need to be externally connected to other apparatuses for achieving the convenience of automatic play and display function.

In view of the above, in the present invention, the display system for automatically pausing/resuming a function adopts the photography unit to retrieve an image and determines the corresponding control action (for example, turning on or off the display) according to the result of analyzing the characteristics of the image. The display system thus has the following advantages:
1. When using an electronic device (for example, using a TV set to watch TV programs, or playing a DVD film in a computer), if the user leaves or the attention thereof is not concentrated due to sudden events (such as going to the bathroom, fetching water or dozing), the present invention can pause the function performed by the electronic device and resumes the function automatically after the events are dealt with.
2. The present invention automatically detects whether or not the user is using or approaching the electronic device, so as to perform a corresponding function. The screens of devices such as auto teller machines (ATMs), public information computers remain in an off state and are turned on when detecting a user is approaching, so as to save the electric power.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. A display system, comprising:
a photography module, for retrieving at least a user characteristic;
a display module, for displaying a video having at least one function; and
a control module, electrically connected to the display module and the photography module, wherein the control module comprises:
a characteristic identification unit, for identifying the user characteristic; and
a control unit, for controlling the function according to the user characteristic identified by the characteristic identification unit.

2. The display system as claimed in claim 1, wherein the photography module comprises a camera.

3. The display system as claimed in claim 1, further comprising:
an audio-visual playback module, for playing the video;
wherein, the display module is electrically connected to the audio-visual playback module for displaying the video played by the audio-visual module; and
wherein, the control unit is further electrically connected to the audio-visual playback module for controlling the audio-visual playback module to pause or resume playing the video according to the user characteristic.

4. The display system as claimed in claim 3, wherein the audio-visual playback module comprises a DVD audio-visual player.

5. The display system as claimed in claim 1, wherein the control unit further controls the function to pause or resume displaying the video according to the user characteristic.

6. The display system as claimed in claim 1, wherein the display module comprises a display of a monitoring system.

7. The display system as claimed in claim 1, wherein the display module comprises a display of a communication apparatus.

8. The display system as claimed in claim 1, wherein the display module comprises a display panel of a public telephone.

9. The display system as claimed in claim 1, wherein the display module comprises a display of a TV set.

10. The display system as claimed in claim 1, wherein the control module controls the function to pause displaying the video when eyes of the user characteristic are taken off the display module; and the control module controls the function to resume displaying the video when eyes of the user characteristic are moved back the display module.

11. The display system as claimed in claim 1, wherein the control module controls the function to pause displaying the video when an action of the user characteristic conforms to a first preset action; and the control module controls the function to resume displaying the video when the action of the user characteristic conforms to a second preset action.

12. The display system as claimed in claim 1, wherein the control module further compares a number of the user characteristics with a preset number, and determines whether to pause or resume displaying according to the comparison result.

13. The display system as claimed in claim 1, wherein the characteristic identification unit is used to identify a distance between the user characteristic and a display frame, the control module further compares the distance between the user characteristic and the display frame with a preset distance, and the display system determines whether to pause or resume displaying according to the comparison result.

14. A method of controlling the display system, wherein the display system comprises a photography module and a display module, and the display module is used to display a video, the method of controlling the display system comprising:
retrieving at least a user characteristic via the photography module;
identifying the user characteristic; and
controlling one function of the display module according to the identified the user characteristic.

15. The method of controlling the display system as claimed in claim 14, wherein the step of controlling comprises pausing and resuming playing the video.

16. The method of controlling the display system as claimed in claim 14, wherein the step of controlling comprises:
controlling the function to pause displaying the video when eyes of the user characteristic are taken off the display module; and
controlling the function to resume displaying the video when eyes of the user characteristic are moved back the display module.

17. The method of controlling the display system as claimed in claim 14, wherein the step of controlling comprises:
controlling the function to pause displaying the video when an action of the user characteristic conforms to a first preset action; and
controlling the function to resume displaying the video when an action of the user characteristic conforms to a second preset action.

18. The method of controlling the display system as claimed in claim 14, wherein the step of controlling comprises:
comparing the number of the user characteristic with a preset number; and
determining whether the function is to pause or resume displaying the video according to a result of the step of comparing.
